(19) United States
(12) Patent Application Publication
(10) Pub. No.: US 2024/0150083 A1
(43) Pub. Date: May 9, 2024

(54) POUCH-TYPE BAG MADE OF PAPER AS WELL AS METHOD AND APPARATUS FOR PRODUCING A POUCH-TYPE BAG MADE OF PAPER

(71) Applicant: Windmöller & Hölscher KG, Lengerich (DE)

(72) Inventors: Jörg Christian THIES, Lengerich (DE); Frank Sander, Lengerich (DE)

(73) Assignee: Windmöller & Hölscher KG, Lengerich (DE)

(21) Appl. No.: 18/550,551

(22) PCT Filed: Mar. 10, 2022
(86) PCT No.: PCT/EP2022/056128

§ 371 Date: Sep. 14, 2023

(30) Foreign Application Priority Data
Mar. 19, 2021 (DE) 10 2021 202 702.4

(51) Int. Cl. B65D 33/16; B31B 70/81; B65D 30/18; B65D 30/20; B65D 33/12; B65D 33/24

(52) U.S. Cl. CPC B65D 33/1691; B31B 70/813; B65D 31/08; B65D 31/10; B65D 33/12; B65D 33/246; B31B 2150/002

(57) ABSTRACT

The invention relates to a pouch-type bag made of paper having a first ply and a second ply, which are connected to one another on their lateral edges and form a filling space, wherein, at its closed end, the pouch-type bag comprises a block-type base or cross-type base and, at its open end via which the filling space can be filled, the lateral edges of the first and second plies terminate on the same plane, wherein at least one sheet is connected to the first ply, which sheet extends beyond the lateral edges of the first and second plies, wherein the sheet is arranged in particular on the side of the first ply facing away from the filling space.

The invention relates to a pouch-type bag made of paper according to claim 1 as well as a method and an apparatus for producing a pouch-type bag made of paper according to claims 7 and/or 8.

Pouch-type bags made of paper have been known for decades and are used in order to transport a wide variety of products, for example, to transport goods purchased in retail.

The starting point of the present invention is such pouch-type bag, which comprises a first ply and a second ply made of paper, which are respectively connected to one another at their lateral edges. These two plies form a filling space in which products can be transported. One end of these pouch-type bags is an end closed with a base. The product can then be filled via the second, open end.

However, it is disadvantageous in these types of pouch-type bags that the goods to be transported are often voluminous, so that the open end is often wide open after the filling of the products, so that the products are not only exposed to weather effects, but also to curious looks from passers-by, especially when the products come from clothing retail. However, if one wishes to roll up the open end in the manner of a bread roll bag, additional paper material is necessary. In addition, the products could be damaged.

The problem addressed by the present invention is therefore to propose a pouch-type bag, a production method, and a production apparatus that at least partially eliminates these disadvantages.

The problem is solved according to the invention by all features of claim 1. The dependent claims specify possible embodiments of the invention.

The subject matter of the present invention is a pouch-type bag made of paper having a first ply and a second ply, which are connected to one another on their lateral edges and form a filling space, wherein, at its closed end, the pouch-type bag comprises a cross-type base and, at its open end via which the filling space can be filled, the lateral edges of the first and second plies terminate on the same plane, wherein a sheet is connected to the first ply, which sheet extends beyond the lateral edges of the first and second plies, wherein the sheet is arranged in particular on the side of the first ply facing away from the filling space.

Accordingly, the invention relates in particular to pouch-type bags with a cross-type base, which are formed from a piece of tubing and are conveyed in a transport direction which extends parallel to the lateral edges, wherein the first ply and the second ply terminate at both a first end and a second end at the same point, and in which a cross-type base is molded at one end. This end is preferably the front end in the production method. The transport direction of the bags during production is simultaneously the longitudinal direction or main direction of the bags, which therefore extends between its two ends. The term cross-type base refers to bases that are created by pulling on one end of the piece of tubing while forming side flaps and side pockets and by pleating parts of the side flaps back.

The lateral edges between the first and the second ply can be configured as simple pleating edges or as side pleats, in which an inwardly folded paper strip is provided on each side, in particular between the two plies. If a pouch-type bag has side gussets, the pleated base is formed in particular as a block-type base. However, if the pouch-type bag does not have side gussets, the base is often referred to as a cross-type base. In both cases, the base of a filled pouch-type bag is essentially formed in a cuboid shape.

According to the invention, a sheet is now connected to the first side, which extends beyond the transverse edge of the first and the second ply, wherein the sheet is arranged in particular on the side of the first ply facing away from the filling space. It is now possible to fold this sheet over in order to cover the open end of the pouch-type bag. The sheet therefore essentially lies in the plane of the first ply prior to the use of the pouch-type bag. Before the filling space is filled, the pouch-type bag is usually opened, wherein the base, which often also substantially lies in the plane of the first ply, is unpleated. After filling the pouch-type bag, the sheet can now be folded over by, for example, 90 degrees but also further. In this way, the filling space is now better protected against weather effects, for example. The pleating edge over which the sheet is folded can be defined by means of a pre-embossing.

It is advantageous when the sheet is a separate workpiece that is connected to the first ply by means of a connection, in particular by means of an adhesive connection. The sheet can thus be applied to the first ply and fastened there, for example, after the pouch-type bag has been completely produced. However, it is preferable to apply it before the end of production and in particular before molding the base. An adhesive connection can be made, for example, by a cold glue, a heat-activated adhesive (hot-melt adhesive), or by applying an extrudate. An adhesive connection can also be produced by means of a piece of material that adheres on both sides, for example with double-sided adhesive labels. However, the separate sheet can also be connected to the first ply in another way, for example by means of adhesive clips, which are often also referred to as staples.

In a further advantageous embodiment of the invention, handle strips are provided, which extend beyond the lateral edges of the first and the second ply, wherein the sheet comprises recesses in the region of the handle strips. In this further development, the handle strips serve to more easily transport the filled pouch-type bag. The handle strips can, for example, be cord handle strips, which consist of twisted yarns. Flat-handle strips are also conceivable, which usually consist of paper strips folded over one another multiple times. It is advantageous when the handle strips are fastened to the surfaces of the first and second plies facing the filling space. In order to be able to at least partially cover the filling space, it is provided according to the invention that the sheet comprises recesses in the region of the handle strips, so that the sheet can also be folded over through the handle strips. The term “recesses” is also intended to mean complete separations, i.e. the sheet can be made in multiple parts and can comprise sheet sections, which are respectively unconnected to another sheet section.

It is particularly advantageous when the sheet can be pleated onto the second ply in order to at least partially close the open end. In this case, not only the open end is covered; rather, the two plies are again moved towards one another in the region of the open end, so that the open end is made smaller by the fact that the sheet presses the first and the second ends together. For this purpose, the sheet is folded over a pleating edge by an angle of more than 90 degrees, but less than 180 degrees.

It is furthermore advantageous when at least one adhesive element is fastened on the second ply, with which adhesive element the sheet can be fastened on the second ply in a state of being pleated onto the second ply, wherein the adhesive element is arranged in particular on the side of the second ply facing away from the filling space. The adhesive element is thus preferably arranged on the outside of the pouch-type bag, just like the sheet. By using an adhesive element, it is now possible to again almost close the open end. The adhesive element can in turn be a double-sided adhesive tape. A liquefied extrudate or a liquefied adhesive glue can also be applied, which provide an adhesive force for the sheet in the recooled state.

In order to prevent the adhesive effect of the adhesive element from subsiding or to prevent other objects from adhere to the adhesive element, a protective element is advantageously provided, with which the adhesive element can be covered before it fulfills its intended purpose of use. The protective element can later be removed from the adhesive element by the user prior to pleating the sheet, so that the sticky outer side of the adhesive element is exposed. The sheet can then be folded over onto the adhesive element.

The aforementioned problem is additionally solved by a method for producing a pouch-type bag made of paper, wherein a paper web is provided, which is flipped over and connected to itself at its lateral edges in order to form a tube, wherein a piece of tube is separated from the tube, having a first ply and a second ply, which are connected to one another at their lateral edges and form a filling space, wherein a block-type base or cross-type base is molded onto the piece of tubing in order to form a closed end, and wherein one end is left open, via which the filling space can be filled, wherein the lateral edges of the first and second plies terminate at the open end on the same plane, wherein at least one sheet is connected to the first ply, which sheet extends beyond the lateral edges of the first and second plies, wherein the sheet is arranged in particular on the side of the first ply facing away from the filling space.

This achieves the same advantages that have already been described above in connection with the device according to the invention.

The aforementioned problem is further soled by an apparatus for producing a pouch-type bag made of paper,
with an unwinding device for unwinding a paper web from a reel,
with a tube formation device, with which parts of the paper web can be flipped over and connected to themselves at their lateral edges in order to form a tube, with a separating device, with which a respective piece of tubing having a first ply and a second ply, which are connected to one another at their respective lateral edges and form a filling space, can be successively separated from the tube,
with a base-forming device for molding a block-type or cross-type base onto a respective piece of tubing in order to form a closed end, wherein one open end remains on the piece of tubing for filling the filling space, wherein, at the open end, the transverse edges of the first and second plies terminate on the same plane,
with a sheet apparatus, with which a sheet can be applied onto the first ply of the piece of tubing and can be connected to the first ply, wherein the sheet extends beyond the lateral edges of the first and the second ply, wherein the sheet can be arranged in particular on the side of the first ply facing away from the filling space.

Further advantages, features, and details of the invention will be apparent from the following description, in which different exemplary embodiments are explained in detail with reference to the figures. The features mentioned in the claims and in the description can always be essential to the invention individually or in any combination of mentioned features. Within the scope of the entire disclosure, features and details described in the context of the method according to the invention naturally always also apply in the context of the apparatus according to the invention and vice versa, so that mutual reference is or can always be made with respect to the disclosure of the individual aspects of the invention. The same applies with respect to the features described in connection with a pouch-type bag according to the invention. These features also apply in connection with a method according to the invention and an apparatus according to the invention. The individual figures show:

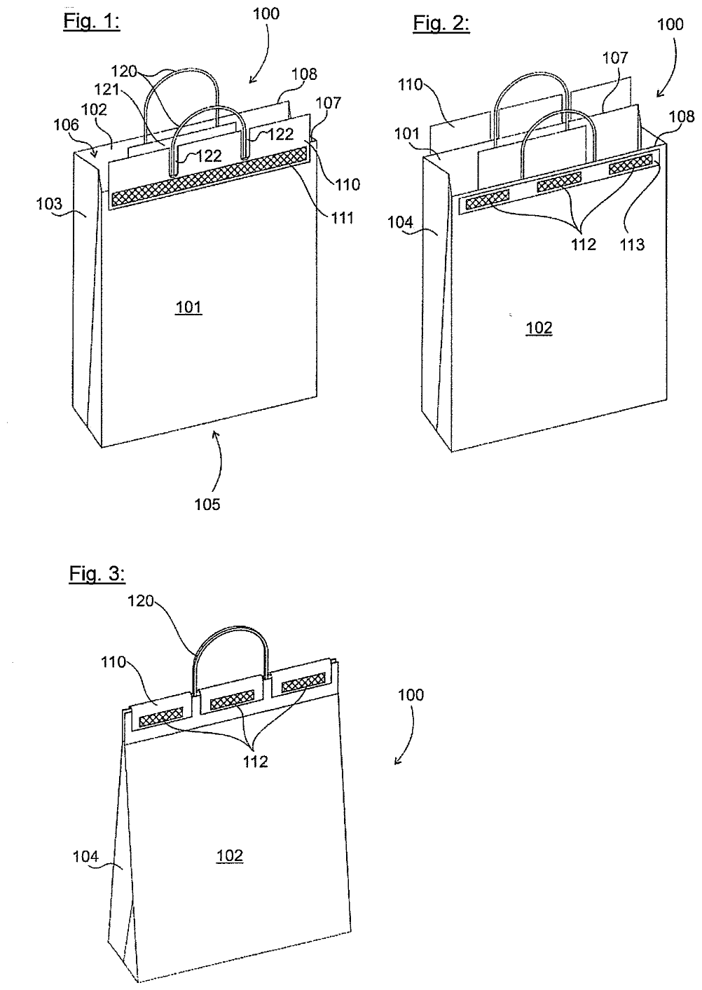

FIG. 1 View of a pouch-type bag according to the invention

FIG. 2 Rearward view of the pouch-type bag from FIG. 1

FIG. 3 Pouch-type bag from FIG. 2, but with the components of a sheet having been folded over.

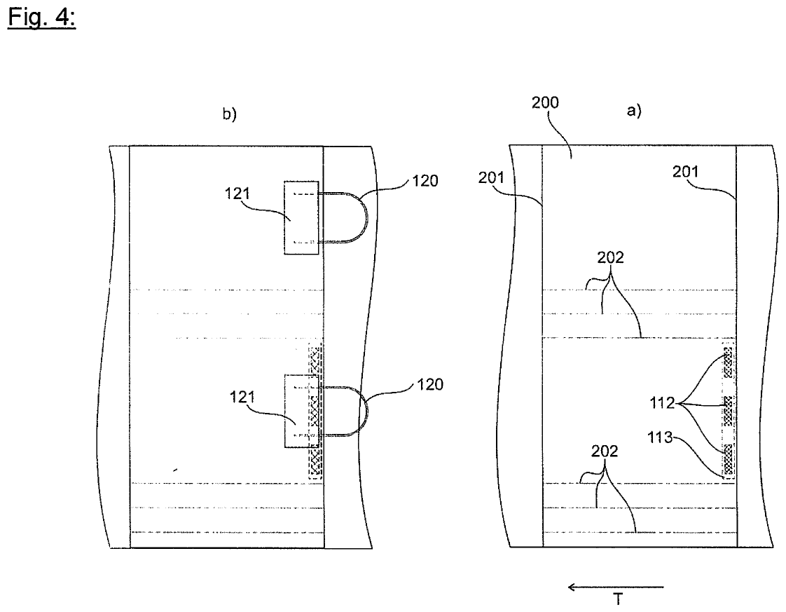

FIG. 4 Illustration of method steps for producing a pouch-type bag according to the invention

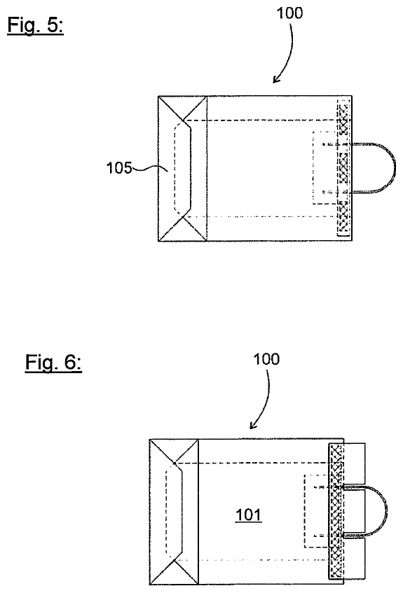

FIG. 5 Pouch-type bag after execution of method steps according to FIG. 4

FIG. 6 Finished pouch-type bag

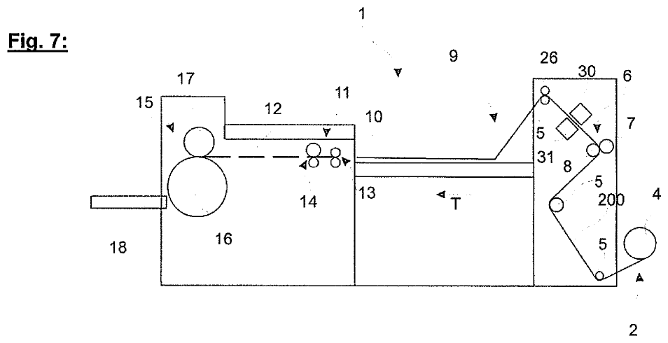

FIG. 7 Apparatus for producing a pouch-type bag according to the invention

FIGS. 1 and 2 show perspective views of a pouch-type bag 100 according to the invention, which comprises a first ply 101 and a second ply 102. These plies 101 and 102 are connected to one another, for example via side gussets 103 and 104, as shown in the aforementioned figures. At the lower end of the pouch-type bag 100, a non-visible base 105 is molded, which essentially has a rectangular shape in the unpleated state as shown. The pouch-type bag 100 comprises an open end 106, via which the pouch-type bag can be filled. At this open end 106, the two plies 101 and 102 each comprise a transverse edge 107 and 108, which, when viewed in the main direction of the pouch-type bag, terminate on the same plane, which means that the edges lie directly on top of one another in the assembled state of the pouch-type bag.

A sheet 110 is connected to the first ply 101, wherein the sheet is preferably located on the outer surface of the ply 101. This sheet 110 extends beyond the transverse edge 107. The sheet 110 preferably extends over at least 60% of the width of the pouch-type bag, in particular over at least 80% of the width of the pouch-type bag. In the region of the surface in which the first ply and the sheet overlap, there is the connecting surface 111 for the sheet on the first ply, wherein the connecting surface is coated with a connective material, which can for example be a cold glue, a hot-melt adhesive, or a double-sided adhesive material.

One or more adhesive surfaces 112 are preferably arranged on the second ply 102. These adhesive surfaces 112 are coated with a protective material 113, for example with a paper coated with silicone, so that the adhesive surfaces initially remain inactive.

Furthermore, the pouch-type bag comprises 100 handle elements 120, which however can also be omitted. Preferably, one respective handle element 120 is arranged on the surfaces of each of the plies 101 and 102 facing the interior and is fastened there. In order to make the fastening more durable, reinforcement sheets 121 can be provided, which are glued onto the aforementioned surfaces of the plies 101 and 102 and are connected to a part of the handle elements 120.

If handle elements 120 are present, it is advantageous when the sheet 110 comprises recesses 122 in the region of the handle elements 120 in order to enable a flipping-over that is unimpeded by the handle elements 120.

FIG. 3 now shows the pouch-type bag according to FIGS. 1 and 2, in which, however, the plies 101 and 102 are pressed together in the region of the open end 106, the protective material 113 has been removed from the adhesive surfaces 112, and the components of the sheet 110 have been flipped over onto the outer surface of the ply 102 and fastened there by means of the adhesive surfaces 112.

FIG. 4 now illustrates essential method steps for producing a pouch-type bag 100 according to the invention. In step a), a section cut from a paper web 200 is initially visible, which represents the basis for the later pouch-type bag. The paper web is transported in the transport direction T, which is simultaneously the direction of the longitudinal axis of the later pouch-type bag. The later transverse separating lines 201, along which the later tube is separated into pieces of tubing, are already seen here. These transverse separating lines run completely orthogonally to the transport direction T and are configured as straight lines. The interrupted lines, which run parallel to the transport direction, represent pleating edges 202 for forming the later side gussets. In a first method step, adhesive surfaces 112 and protective material 113 are applied to each later piece of tubing on the back of the paper web 200, i.e. on the side facing away from the observer.

In a further step b), which can be carried out before, after, or even at the same time as the step described above, handle elements 120 and optional reinforcement sheets 121 are applied and fastened on the visible side of the paper web 200. Subsequently, in a method step not shown, a tube is formed from the paper web 200 by flipping the edges of the paper web in the direction of the observer and connecting them to one another. The side gussets are inserted during this step or shortly thereafter. A step is then performed in which the tube is singled into pieces of tubing. This can be done by a cutting tool, which makes cuts along the lines 201. A perforation of the lines 201 can also be carried out alternatively or additionally before the handle elements are applied. In the step of singling, a piece of tubing can then be torn away from the tube. In a further step, which does not necessarily take place before the steps described in connection with FIGS. 5 and 6, a base, in particular a block-type base, is formed.

FIG. 5 shows a pouch-type bag as it appears after the method steps described in connection with FIG. 4. The base 105 can now be seen in this illustration.

In a final method step, a sheet 110 is now applied onto the pouch-type bag 100. For this purpose, a sheet can be separated from a sheet web (not shown) and equipped with optional recesses 122. To carry out this step, one or more punching and/or cutting tools can be provided, which in turn are not shown. An adhesive can then be applied to the sheet 122 and/or to the region of the first ply 101 onto which the sheet is to be affixed. The next step is to apply and thus fasten the sheet onto the first ply 101. This situation is shown in FIG. 6.

FIG. 7 shows an apparatus 1 for producing pouch-type bags 100. In this figure, the essential components of this apparatus are shown schematically. The apparatus 1 comprises an unwinding device 2, to which the paper web 200 is fed in the form of a reel 4. Starting from this reel 4, the material web 200 is fed via guide rollers 5 to an optional transverse cutting station 6 or perforating station 6. This station 6 can comprise one or more transverse cutting or transverse perforating blades, not shown in more detail, which rotate on a roller 7. In particular, in this station, regions of the lines 201 can be pre-perforated or pre-cut, with which the handle element 120 later intersects. Instead of blades, contactless cutting apparatuses, such as a laser cutting apparatus, can also be used in this station.

In this station 6, the material web 200 can run over a counterpressure roller 8, the main purpose of which is to provide the counterpressure required for the cutting or perforating operation. During this cutting or perforation operation, the web is not cut all the way through.

In the further course, an optional handle application station 30 is now provided, with which handle elements 120 and reinforcement sheets 121 can be fastened to the paper web 200 according to the method steps described in connection with FIGS. 4 through 6.

Downstream of the station 6, an adhesive surface application station 31 is also provided, with which the adhesive surfaces 112 and the protective material 113 can be applied to the surface of the paper web 200 facing away from the handle element. The station 31 can also be arranged upstream of the station 6.

The material web 200 then passes through a nip formed by a further guiding roller 5 and a roller designed as a longitudinal gluing unit 26. The latter applies glue to one side region of the material web 3 so that both side regions are permanently bonded to one another after the tube formation described below.

In the following tube formation station 9, a tube 10 is formed from the material web 200 by laterally pushing on the material web 200 by means of guide elements, such as guide plates, so that the edges of the material web then overlap. The subsequently overlapping regions have already been provided with a suitable adhesive by means of the longitudinal gluing unit 26. Side gussets can also be inserted during the pushing of the paper web. However, in principle, the side gussets can also be inserted after the tube has been formed. The tube 10 is now fed further essentially in the transport direction T.

After the tube 10 has been produced, it is singled into pieces of tubing 12 in the singling station 11. For this purpose, the tube 10 is fed through the nip of a pair of rollers 13. One of the rollers of the pair of rollers 13 is designed as a cutting roller. It preferably comprises at least one cutting blade, which extends transversely to the transport direction T and in particular comprises recesses in the region of the handle elements in order not to cut through them. Of course, a plurality of individual blades can also be provided, which are spaced apart from one another in the region of the handle elements. The individual blades are nevertheless located on a single cutting line and can be displaced relative to the cutting roller.

During the further advance of the tube, it enters the nip of an optional second pair of rollers 14. The rollers of the second pair of rollers can constantly or at least temporarily have a greater circumferential speed than the rollers of the first pair of rollers 13 in order to generate a distance between the last separated piece of tubing and the newly created leading end of the tube.

The piece of tubing torn away from the tube now reaches the base-pleating station 15, whose exact assembly is not discussed further herein. In connection with the invention, however, the application station 17 is important for the sheets 110, with which the sheets can be applied onto the pouch-type bag 100. This application has already been described in further detail in connection with FIGS. 4 through 6.

Once the pouch-type bag has been finished, it is placed on a table 18 by means of the base-making cylinder 16. The pouch-type bags are usually arranged perpendicularly. The pouch-type bags can then be appropriately removed from this table 18 in batches.

List of reference numerals

| | |
|---|---|
| 100 | Pouch-type bag |
| 101 | First ply |
| 102 | Second ply |
| 103 | Side gusset |
| 104 | Side gusset |
| 105 | Base |
| 106 | Open end |
| 107 | Transverse edge |
| 108 | Transverse edge |
| 110 | Sheet |
| 111 | Connecting surface |
| 112 | Adhesive surface |
| 113 | Protective material |
| 120 | Handle elements |
| 121 | Reinforcement sheet |
| 122 | Recess |
| 200 | Paper web |
| 201 | Transverse separating line |
| 202 | Pleating edge |
| 1 | Apparatus for producing pouch-type bags 100 |
| 2 | Unwinding device |
| 3 | Material web |
| 4 | Reel |
| 5 | Guide roller |
| 6 | Transverse cutting station/perforating station |
| 7 | Roller |
| 8 | Counterpressure roller |
| 9 | Tube formation station |
| 10 | Tube |
| 11 | Singling station |
| 12 | Piece of tubing |
| 13 | Pair of rollers |
| 14 | Pair of rollers |
| 15 | Base-pleating station |
| 16 | Base-making cylinder |
| 17 | Application station |
| 18 | Table |
| 26 | Longitudinal gluing |
| 30 | Handle application station |
| 31 | Adhesive surface application station |
| T | Transport direction |

1. Pouch-type bag made of paper having a first ply and a second ply, which are connected to one another on their lateral edges and form a filling space, wherein, at its closed end, the pouch-type bag comprises a block-type base or cross-type base and, at its open end via which the filling space can be filled, the lateral edges of the first and second plies terminate on the same plane, wherein at least one sheet is connected to the first ply, which sheet extends beyond the lateral edges of the first and second plies, wherein the sheet is arranged in particular on the side of the first ply facing away from the filling space.

2. Pouch-type bag according to claim 1,
characterized in that
the sheet is a separate workpiece, being connected to the first ply by means of an adhesive connection.

3. Pouch-type bag according to claim 1,
characterized in that
handle strips are provided, which extend beyond the lateral edges of the first and second plies, wherein the sheet comprises recesses in the region of the handle strips.

4. Pouch-type bag according to claim 1,
characterized in that
the sheet can be pleated onto the second ply in order to at least partially close the open end.

5. Pouch-type bag according to claim 1,
characterized in that
at least one adhesive element is fastened on the second ply, with which adhesive element the sheet can be fastened on the second ply in a state of being pleated onto the second ply, wherein the adhesive element is arranged in particular on the side of the second ply facing away from the filling space.

6. Pouch-type bag according to claim 1,
characterized in that
the adhesive element is covered with a protective element before use.

7. Method for producing a pouch-type bag made of paper, wherein a paper web is provided, which is flipped over and connected to itself at its lateral edges in order to form a tube, wherein a piece of tube is separated from the tube, having a first ply and a second ply, which are connected to one another at their lateral edges and form a filling space, wherein a block-type base or cross-type base is molded onto the piece of tubing in order to form a closed end, and wherein one end is left open, via which the filling space can be filled, wherein the lateral edges of the first and second plies terminate at the open end on the same plane, wherein at least one sheet is connected to the first ply, which sheet extends beyond the lateral edges of the first and second plies, wherein the sheet is arranged in particular on the side of the first ply facing away from the filling space.

8. Apparatus for producing a pouch-type bag made of paper,
with an unwinding device for unwinding a paper web from a reel,
with a tube formation device, with which parts of the paper web can be flipped over and connected to themselves at their lateral edges in order to form a tube,
with a separating device, with which a respective piece of tubing having a first ply and a second ply, which are connected to one another at their respective lateral edges and form a filling space, can be successively separated from the tube,
with a base-forming device for molding a block-type or cross-type base onto a respective piece of tubing in order to form a closed end, wherein one open end remains on the piece of tubing for filling the filling space, wherein, at the open end, the transverse edges of the first and second plies terminate on the same plane,
with a sheet apparatus, with which a sheet can be applied onto the first ply of the piece of tubing and can be connected to the first ply, wherein the sheet extends beyond the lateral edges of the first and the second ply, wherein the sheet can be arranged in particular on the side of the first ply facing away from the filling space.
